(19) United States
(12) Patent Application Publication
(10) Pub. No.: US 2006/0073734 A1
(43) Pub. Date: Apr. 6, 2006

(54) Tool for connecting a data transmission cable to equipment

(76) Inventors: Bart Delsaert, Overijse (BE); Jurgen Van Ranst, Merchtem (BE)

Correspondence Address: SOFER & HAROUN, L.L.P.;Suite 910, 317 Madison Avenue, New York, NY, 10017, US

(21) Appl. No.: 11/208,045

(22) Filed: Aug. 18, 2005

(30) Foreign Application Priority Data
Aug. 27, 2004 (FR) 04 51 915

(51) Int. Cl. H01R 13/648

(52) U.S. Cl. 439/607

(57) ABSTRACT

A data transmission cable stripping tool comprises a device for holding conductors in position and a device for cutting wraps of said conductors in a common plane. The cable comprises a plurality of said conductor pairs wrapped in a metal film, said holding device holds the conductor pairs in position, and said cutting device cuts the wraps of said conductor pairs and also fits said cable to an equipment.

### RELATED APPLICATIONS

This application is related to and claims the benefit of priority from French Patent Application No. 04 51915, filed on Aug. 27, 2004, the entirety of which is incorporated herein by reference.

### BACKGROUND OF THE INVENTION

1. Field of the Invention

The invention relates to a tool for connecting a data transmission cable to equipment.

2. Description of the Prior Art

To fit this type of cable to equipment such as a terminal portion of a connector, it is necessary to cut off a section of the outer jacket first in order to free the conductor pairs wrapped in their metal films. The outer jacket may be removed by means of a tool that is known in the art.

The conductor pairs, of which there are four, for example, must then be arranged so that certain conductor pairs cross over in accordance with a fitting condition that is imperative, a length of each metal wrap must be removed, and the ends of the conductors released in this way are inserted into the contacts of the equipment to make the connection.

The operations following removal of the outer jacket are effected manually using a tool for cutting the wrap.

Now, it is desirable for the conductors stripped of their metal wrap to be of constant and particular length in order to make the connection to the equipment correctly.

This accuracy cannot be achieved with totally manual operation, especially as the crossovers between conductor pairs lead to a variation in the lengths of the conductors outside the outer jacket connected to the equipment and increases the inaccuracy. It may even happen that the length of metal wrap removed proves to be too short and that the corresponding length of stripped conductor is too short to make a reliable connection to the equipment.

Moreover, the manual operation is relatively delicate and time-consuming.

The invention solves the above problems by providing a tool for fitting a data transmission cable to equipment precisely and reliably.

### SUMMARY OF THE INVENTION

To this end, the invention proposes a data transmission cable stripping tool comprising a device for holding conductors in position and a device for cutting wraps of said conductors in a common plane, characterized in that said cable comprises a plurality of said conductor pairs wrapped in a metal film, said holding device holds the conductor pairs in position, said cutting device cuts the wraps of said conductor pairs and also fits said cable to an equipment.

By means of the above tool, the operation of preparing the conductors and connecting them to the equipment may be carried out repetitively and identically.

A preferred embodiment of the tool further comprises an arrangement for placing said equipment on said conductor pairs.

Said holding device preferably comprises two clamp-type branches articulated to move between an open configuration and a closed configuration, a first end of the branches constituting a holding arrangement comprising facing slots separated by a central bar mounted on a pivot pin of said branches and a second end constituting a holding arrangement.

Said cutting device advantageously consists of an arrangement sliding on said holding device and including at least four cutting blades.

The holding device and said sliding arrangement are preferably designed so that the latter locks the holding device in the closed configuration or releases it from the closed configuration according to the relative positions of the two devices.

Said cutting blades are advantageously carried by three cutters fixed to said sliding arrangement on one face of the holding device, two external cutters carrying a cutting blade directed toward said central bar and a central cutter carrying two cutting blades parallel to the preceding blades.

Said arrangement for placing the equipment preferably consists of cavities on said first ends of the branches and on said bar, said cavities together forming in the closed configuration a cavity in which said equipment may be nested.

The tool may comprise marks for identifying the positions of the conductor pairs.

It may also comprise marks for identifying the position of the equipment and the positions of the conductors.

The invention also relates to a method of fitting a data transmission cable to an equipment, said cable including a plurality of conductor pairs each wrapped in a metal film and stripped of an outer jacket, which method is characterized in that it includes the following steps:

crossing over the conductor pairs stripped of the outer jacket in accordance with fitting conditions,

inserting conductor pairs into said holding device until the end of the outer jacket abuts against the device,

actuating the cutting device to cut the metal wraps,

removing the cut lengths of metal wrap.

The method preferably includes the following subsequent steps:

inserting the conductors into the equipment and fitting the equipment to the tool,

connecting the conductors to the equipment,

removing the equipment and the conductors fitted thereto.

The method advantageously comprises the following steps:

inserting the conductor pairs into said holding device by inserting the conductors into said slots with the tool in the closed configuration until the end of the outer jacket abuts against the device,

after removing the cut lengths of metal wrap, pulling the conductor pairs in order for the tool to clamp their remaining wrap.

The invention is described in more detail hereinafter with reference to figures showing a preferred embodiment of the invention.

### BRIEF DESCRIPTION OF THE DRAWINGS

FIG. 1 is a front perspective view of a tool of the invention in a closed configuration.

FIG. 2 is an exploded front perspective view of the tool of the invention.

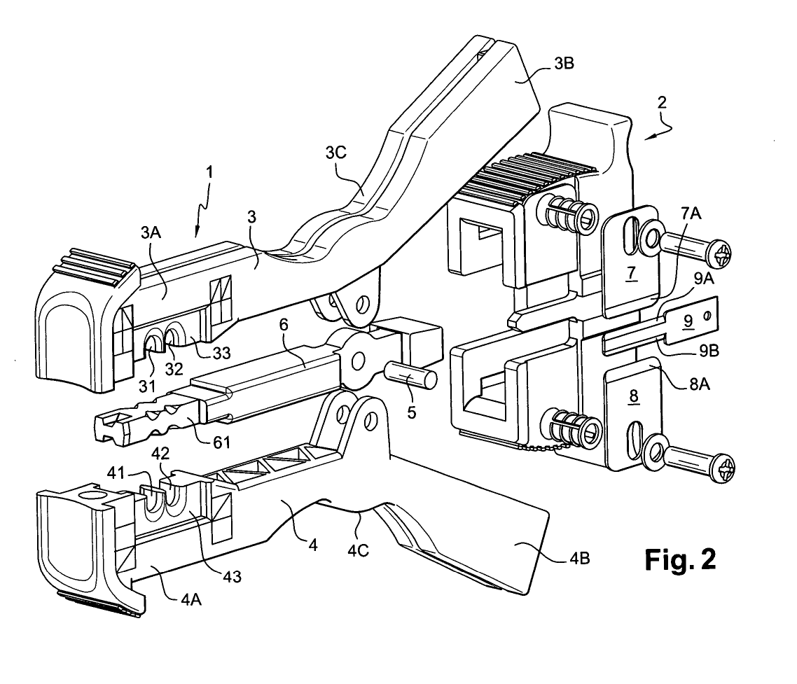

FIG. 3 is a front plan view of the tool of the invention in a closed configuration.

FIG. 4 is a rear plan view of the tool of the invention in the closed configuration.

FIG. 5 is a plan view of the tool of the invention in the closed configuration.

FIG. 6 is a front perspective view of the tool of the invention in the closed configuration during a cutting operation.

FIG. 7 is a front perspective view of the tool of the invention in the closed configuration with the equipment fitted to the tool.

FIG. 8 is a front perspective view of the tool of the invention in an open configuration.

### DETAILED DESCRIPTION OF THE PREFERRED EMBODIMENT

As may be seen in the figures, a tool for stripping a data transmission cable includes a device 1 for holding conductors in position and a device 2 for cutting the wraps of the conductors in the same plane. The cable comprises a plurality of conductor pairs A, B, C, D wrapped in a metal film A1, B1, C1, D1. The holding device 1 holds the conductor pairs in position and the cutting device 2 cuts the wraps of the conductor pairs. The tool is also used to connect said cable to an equipment F.

The holding device 1 comprises two branches 3, 4, of the clamp type articulated about a pivot pin 5 to move between an open configuration and a closed configuration.

A first end 3A, 4A of the branches constitutes a holding arrangement comprising facing slots 31, 32, 41, 42 separated by a central bar 6 mounted on the pivot pin 5 of said branches and a second end 3B, 4B constitutes a holding arrangement.

The cutting device 2 consists of an arrangement sliding on the holding device 1 and includes at least four cutting blades.

The cutting blades are carried by three cutters 7, 8, 9 fixed to the sliding arrangement 2 and disposed on the front face of the holding device 1, two external cutters 7, 8 carrying a cutting edge 7A, 8A directed toward the central bar 6 and a central cutter 9 carrying two cutting blades 9A, 9B parallel to and facing the previous ones.

The cutters 7, 8, 9 are removable. They may be easily replaced when worn out. Moreover, the position of the external cutters 7, 8 may be adjusted because they are fixed by means of screws in oblong holes. The central cutter 9 may be clipped on.

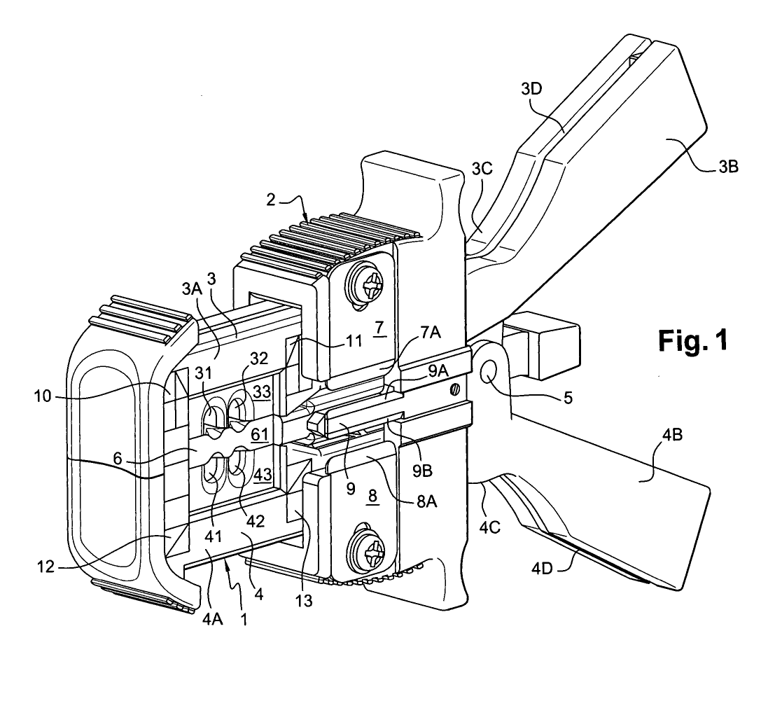

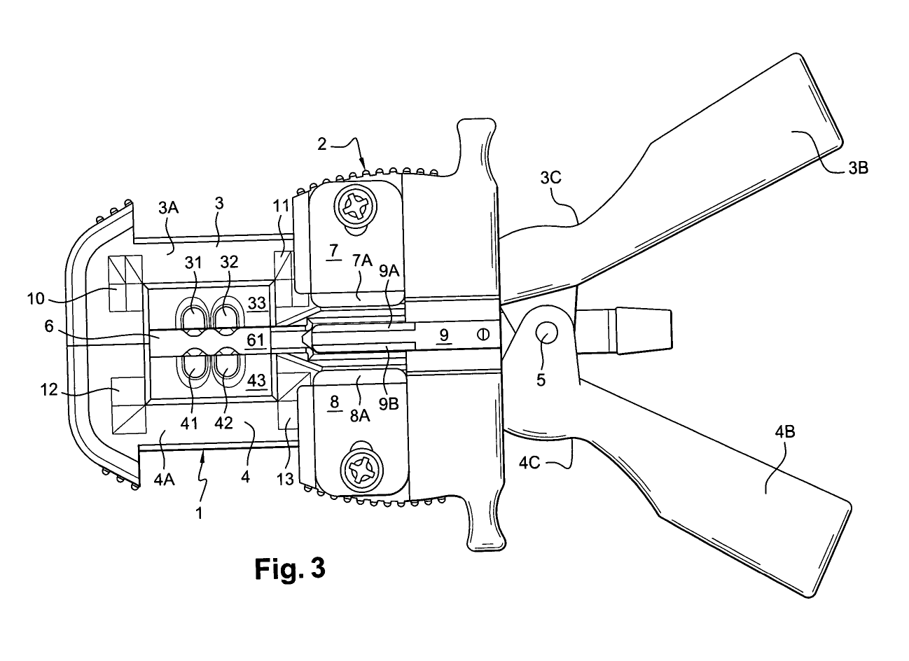

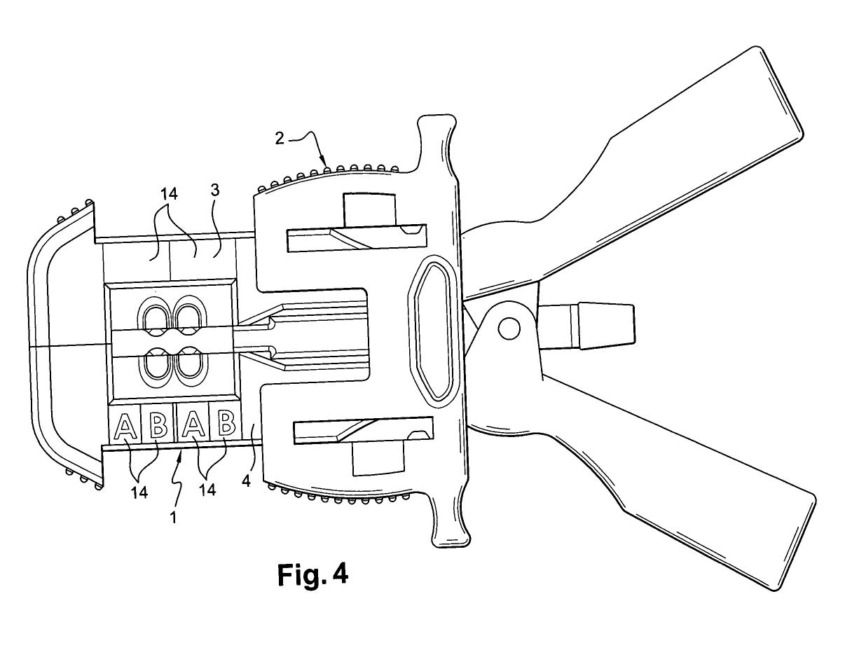

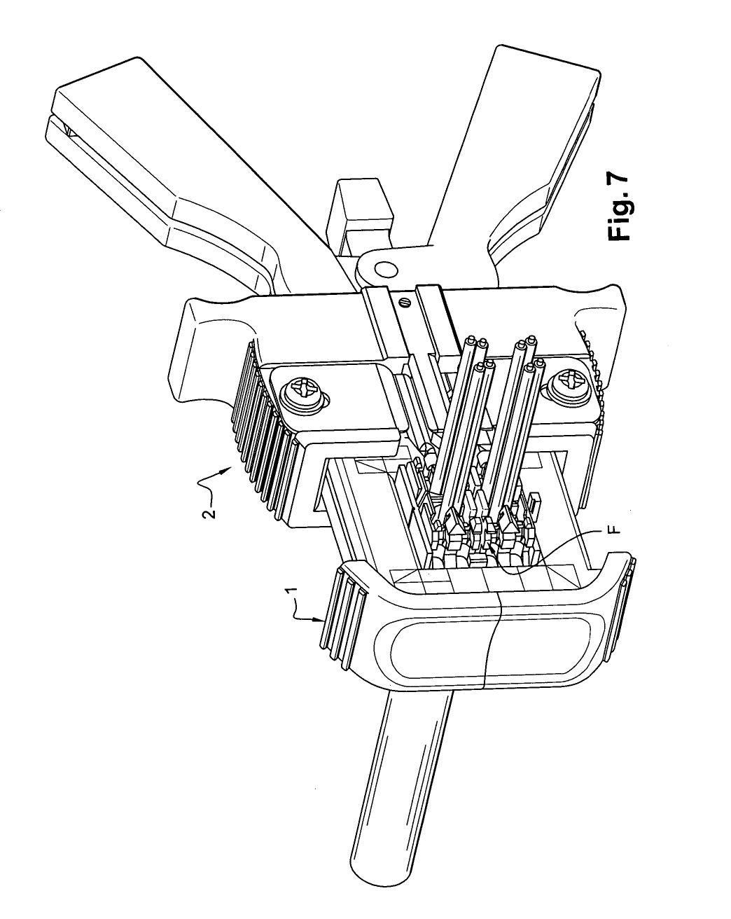

The holding device 1 and the sliding arrangement 2 are designed so that the latter locks the holding device 1 in the closed configuration or releases it from the closed configuration, according to the relative position of the two devices. To be more precise, branches 3, 4 of the holding device 1 have a wide V-shape and, at the bottom of this V-shape, curved portions that open the holding device 3, as shown in FIG. 7, when the cutting arrangement 2 slides towards the holding ends 3B, 4B, and close the holding device 3, as shown in FIGS. 1, 3 and 4, when the cutting arrangement 2 slides toward the holding ends 3A, 4A.

Each branch 3, 4 includes a longitudinal groove on the upper and lower faces of the tool as seen in FIG. 1.

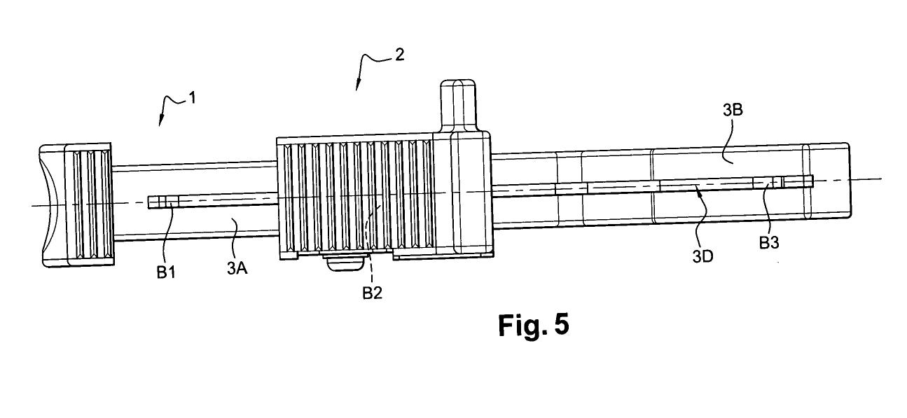

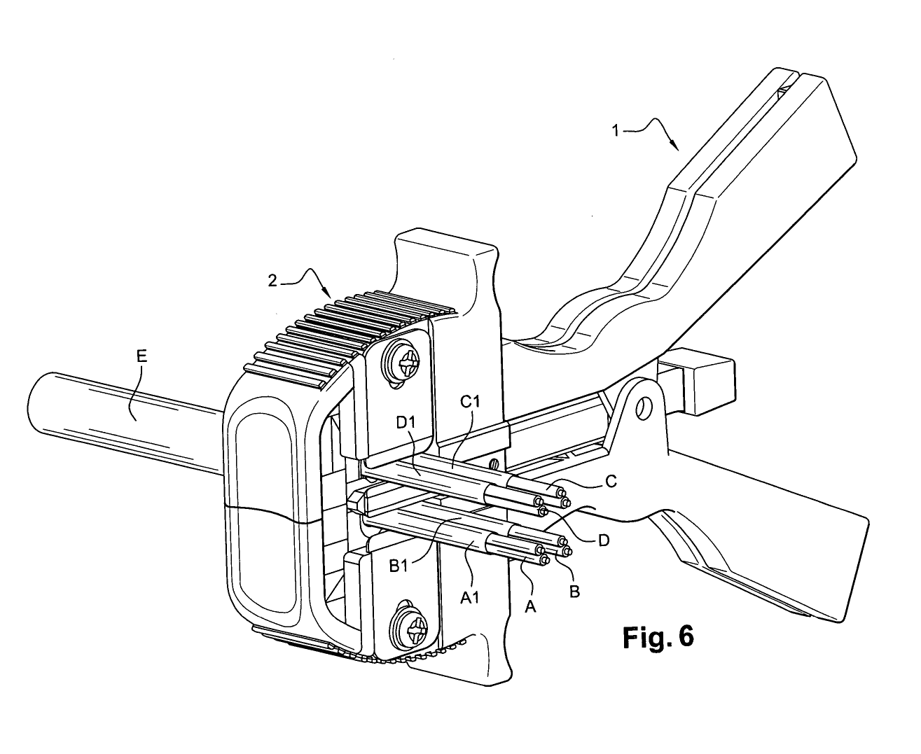

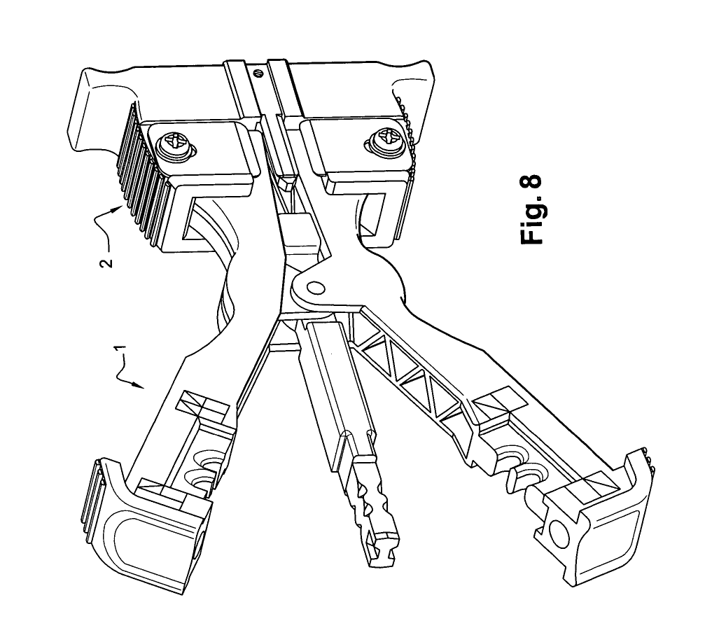

The upper face of the tool and a longitudinal groove 3D on the corresponding branch 3 can be seen in FIG. 5. The other branch 4 is symmetrical and has a groove 4D of this kind on the lower face of the tool. A pawl carried by the cutting device 2 slides in this groove 3D, which comprises three abutment arrangements that can be unlocked by pushing the cutting device 2. A first abutment arrangement B1 locks the cutting device 2 at the end of cutting position shown in FIG. 6. A second abutment arrangement B2 locks the cutting device 2 in the closed configuration shown in FIGS. 1, 3, 4 and 5. A third abutment arrangement B3 locks the cutting device 2 in the open configuration shown in FIG. 8.

The tool further comprises an arrangement for placing the equipment on the conductor pairs.

This equipment placing arrangement consists of cavities 33, 61, 43 formed at the holding ends 3A, 4A of the branches and on the bar 6, these cavities together forming a cavity around conductor insertion slots 31, 32, 41, 42, in which cavity the equipment is nested in the closed configuration. In the embodiment shown in the figures, this cavity is substantially square and corresponds to the section of a terminal portion of a connector conventionally used for data transmission cables of this kind. As a general rule, the shape of this cavity is adapted to the section of the equipment, which may be any shape, for example rectangular or hexagonal.

The tool, and to be more precise the holding device 1, advantageously comprises on its rear face marks 14 for identifying the relative position of the conductor pairs to facilitate the correct disposition of the conductor pairs relative to each other.

It also has on its front face marks 10 to 13 for identifying the position of the equipment and the relative positions of the conductors.

A data transmission cable comprises a plurality of conductor pairs A, B, C, D wrapped in respective metal films A1, B1, C1, D1 and stripped of an outer jacket E, as may be seen in FIG. 5. The method of fitting the cable to an equipment F using the above tool includes the following steps:

crossing over conductor pairs stripped of the outer jacket E in accordance with the fitting conditions and as close as possible to the end of the outer jacket E;

inserting conductor pairs A, B, C, D into the slots 31, 32, 41, 42 of the holding device 1 via the rear face of the tool and in accordance with the identifying marks 14 carried by the rear face of the holding device, until they abut against the rear face of the device, which is in the closed configuration shown in FIG. 1, the cutting device being locked onto the second abutment arrangement B2;

pushing the cutting device 2 over the conductor pairs by moving it in translation in the direction of the holding ends 3A, 4A, as shown in FIG. 5, the cutting device being locked to the first abutment arrangement B1;

removing the cut off lengths of metal wrap;

pulling the conductor pairs forward, in order for the tool to clamp the remaining wrap, followed by a return to the initial position;

moving the cutting device 2 in translation in the direction of the holding ends 3B, 4B and without crossing the base of the V-shape formed by the branches 3, 4 of the holding device, as shown in FIG. 1;

inserting the conductors, still held in the holding device, into the equipment F with the assistance of the identifying marks 10 to 13 and placing the part F on the tool, in the cavity formed by the cavities 33, 61, 43 in the holding ends 3A, 4A of the branches and the bar 6, as shown in FIG. 6;

connecting the conductors to the equipment F according to the corresponding identifying marks 10 to 13 carried by the front face of the holding device;

moving the cutting device 2 in translation in the direction of the holding end 3B, 4B, across the base of the V-shape formed by the branches 3, 4 of the holding device, which causes the holding device 1 to open, the cutting device being locked to the third abutment arrangement B3;

removing the equipment and the conductors fitted thereto from the bar 6, the tool being in the open position shown in FIG. 7;

cutting off the conductors level with the equipment.

In the preferred embodiment of the invention, the tool is adapted to fit an electrical data transmission cable to four conductor pairs. In the context of the invention, the tool may of course be adapted to deal with electrical cables comprising a different number of conductor pairs by modifying the number and the disposition of the slots accordingly.

There is claimed:

1. A data transmission cable stripping tool comprising:
a device for holding conductors in position; and
a device for cutting wraps of said conductors in a common plane, wherein said cable has a plurality of said conductor pairs wrapped in a metal film, said holding device holding the conductor pairs in position, and said cutting device cutting the wraps of said conductor pairs and also fitting said cable to an equipment.

2. The tool claimed in claim 1, further comprising an arrangement for placing said equipment on said conductor pairs.

3. The tool claimed in claim 1, wherein said holding device further comprises two clamp-type branches articulated to move between an open configuration and a closed configuration, a first end of the branches constituting a holding arrangement having facing slots separated by a central bar mounted on a pivot pin of said branches and a second end constituting a holding arrangement.

4. The tool claimed in claim 1, wherein said cutting device consists of an arrangement sliding on said holding device and including at least four cutting blades.

5. The tool claimed in claim 4, wherein said holding device and said sliding arrangement are designed so that the latter locks the holding device in the closed configuration or releases it from the closed configuration according to the relative positions of the two devices.

6. The tool claimed in claim 3, wherein said cutting blades are carried by three cutters fixed to said sliding arrangement on one face of the holding device, two external cutters carrying a cutting blade directed toward said central bar and a central cutter carrying two cutting blades parallel to the preceding blades.

7. The tool claimed in claim 2, wherein said arrangement for placing the equipment includes cavities on said first ends of the branches and on said bar, said cavities together forming in the closed configuration a cavity in which said equipment may be nested.

8. The tool claimed in claim 1, further comprising marks for identifying the positions of the conductor pairs.

9. The tool claimed in claim 1, further comprising marks for identifying the position of the equipment and the positions of the conductors.

10. A method of fitting a data transmission cable to an equipment using the tool claimed in claim 1, said cable including a plurality of conductor pairs each wrapped in a metal film and stripped of an outer jacket, said method includes the following steps:
crossing over the conductor pairs stripped of the outer jacket in accordance with fitting conditions,
inserting conductor pairs into said holding device until the end of the outer jacket abuts against the device,
actuating the cutting device to cut the metal wraps,
removing the cut lengths of metal wrap.

11. The fitting method claimed in claim 10 further including the following subsequent steps:
inserting the conductors into the equipment and fitting the equipment to the tool,
connecting the conductors to the equipment,
removing the equipment and the conductors fitted thereto.

12. The fitting method claimed in claim 10 further comprising the following steps:
inserting the conductor pairs into said holding device by inserting the conductors into said slots with the tool in the closed configuration until the end of the outer jacket abuts against the device,
after removing the cut lengths of metal wrap, pulling the conductor pairs in order for the tool to clamp their remaining wrap.
